(19) United States
(12) Patent Application Publication
(10) Pub. No.: US 2014/0193017 A1
(43) Pub. Date: Jul. 10, 2014

(54) PORTABLE AUDIO DEVICE AND HOUSING

(71) Applicant: Wendy FORTIN, Spencer, MA (US)

(72) Inventor: Wendy FORTIN, Spencer, MA (US)

(73) Assignee: inMusic Brands, Inc., Cumberland, RI (US)

(21) Appl. No.: 13/736,728

(22) Filed: Jan. 8, 2013

(51) Int. Cl. H04R 1/02

(52) U.S. Cl. CPC H04R 1/02
USPC 381/334; 206/37

(57) ABSTRACT

A portable audio device has a gate member that is spring activated to allow for attachment to other articles. The spring-activated gate member is integrated within the portable audio device. The portable audio device includes a receiver and transmitter for communication of wireless data. When the receiver receives audio signals, they may be outputted to a speaker that is part of the portable audio device. The portable audio device includes a waterproof portion.

### FIELD OF THE DISCLOSURE

The present disclosure relates to audio input and output devices.

### BACKGROUND

Speakers provide users with the ability to listen to audio. While many speakers are designed to provide the best possible sound, many such speakers are cumbersome and difficult to move around easily. As a result, portable speakers have been designed that allow a user to easily move between locations while still being able to enjoy audio. Some portable speakers, such as headphones, are designed for personal use, while others are designed for group listening. While some portable speakers do provide users the opportunity to listen to audio while in transit or while enjoying recreational activities, these speakers tend not to produce sound of high quality, and/or tend not to be sufficiently durable for use during vigorous physical activities, or for outdoor activities performed during inclement weather.

Mobile audio devices currently exist that allow users to listen to audio while on the go. Traditionally, these devices were smaller, more compact versions of traditional audio equipment, such as personal stereos, cassette players, and compact disc players. More recently, mobile computing devices have become popular solutions for mobile audio listening. For example, many laptops and mobile phones are capable of playing audio. In addition, specialized mobile computing devices for playing audio, such as MP3 players, have become a popular way for a user to enjoy music while on the go. Generally, mobile audio devices are intended to be used with headphones, but some speaker systems have been designed for use with mobile audio devices. Most headphones and speaker systems designed for use with mobile audio devices, however, use a wired connection to receive an audio signal from the mobile audio device, and like many portable speakers, most mobile audio devices are not designed to be exposed to inclement weather.

### SUMMARY

The present disclosure describes a portable audio device. The portable audio device has a compact and lightweight design, yet produces high quality sound. In addition, the portable audio device is waterproof, making it suitable for activities that may cause the device to get wet.

The portable audio output device may include a loop portion, a waterproof housing and a wireless receiver. The wireless receiver may be adapted to receive an audio signal and output the audio signal to a speaker. The waterproof housing and the loop portion are connected such that they share an exterior surface. Additional features of the portable audio device may include a transmitter and a microphone. The transmitter may be adapted to transmit audio signals detected by the microphone. The portable audio device may also include control buttons, and the transmitter may transmit control signals generated in response to the activation of the control buttons.

The present disclosure also describes another embodiment of a portable audio device. The portable audio device includes a carabiner clip with a gate and a frame. The frame may include a waterproof housing in which a wireless receiver, a wireless transmitter and a speaker are disposed. The speaker may output audio signals received by the wireless receiver. An additional feature of the portable audio device may be a microphone. The transmitter may be adapted to transmit audio signals detected by the microphone. The portable audio device may also include control buttons, and the transmitter may transmit control signals generated in response to the activation of the control buttons.

The present disclosure also describes a device housing. The device housing may include a first edge capable of being configured in an open configuration or a closed configuration. The device housing may also include a spring-loaded hinged member pivotable along a first edge of the device housing. Disposed along the first edge of the device housing may be an engaging member that is adapted to couple to the spring loaded hinged member such that when the spring-loaded hinged member couples to the engaging member, the spring loaded hinged member and the engaging member place the first edge in the closed configuration. Further, when the spring-loaded hinged member decouples from the engaging member, the spring-loaded hinged member and the engaging member place the first edge in an open configuration. The device housing may also include a second edge that has an exterior surface and an interior surface forming a component cavity. One or more waterproof seals may be disposed within the component cavity and/or along the exterior surface such that water does not enter the component cavity when the exterior surface is exposed to water. Additional features of the device housing may include a wireless receiver, a speaker, and control buttons.

Additional objects and advantages will be set forth in the description which follows. Yet other objects and advantages may be learned from practicing embodiments described herein. The objects and advantages discussed in this disclosure will be realized and attained by means of the elements and combinations particularly disclosed in the appended claims.

It is to be understood that both the foregoing general description and the following detailed description are exemplary and explanatory only and are not restrictive.

The accompanying drawings, which are incorporated in and constitute a part of this specification, illustrate several embodiments of the subject matter of this disclosure and together with the description, serve to explain the principles of the devices described herein.

### BRIEF DESCRIPTION OF THE DRAWINGS

FIG. 1A illustrates a front view of one embodiment of a portable audio device with a gate member in a closed configuration.

FIG. 1B illustrates a front view of one embodiment of a portable audio device with a gate member in an opened configuration.

FIG. 2A illustrates one embodiment of a portable audio device in communication with a source device.

FIG. 2B illustrates one embodiment of a portable audio device in communication with a source device.

FIG. 3 illustrates one embodiment of a portable audio device in a closed configuration, attached to a backpack, and in communication with a mobile source device.

FIG. 4A illustrates a left side view of one embodiment of a portable audio device with a gate member in a closed configuration.

FIG. 4B illustrates a right side view of one embodiment of a portable audio device.

FIG. 5A illustrates a horizontal cross-section view of a bottom portion of a portable audio device according to one embodiment.

FIG. 5B illustrates a horizontal cross-section view of a top portion of a portable audio device according to one embodiment.

FIG. 6 illustrates a front view of one embodiment of a portable audio device with a gate member in a closed configuration.

FIG. 7 illustrates a block diagram of components of a portable audio device according to one embodiment.

FIG. 8 illustrates a front view of one embodiment of a portable audio device with a hook member.

### DESCRIPTION OF EMBODIMENTS

Reference will now be made in detail to the exemplary embodiments of the portable audio device, examples of which are illustrated in the accompanying drawings. Wherever possible, the same reference numbers will be used throughout the drawings to refer to the same or like parts.

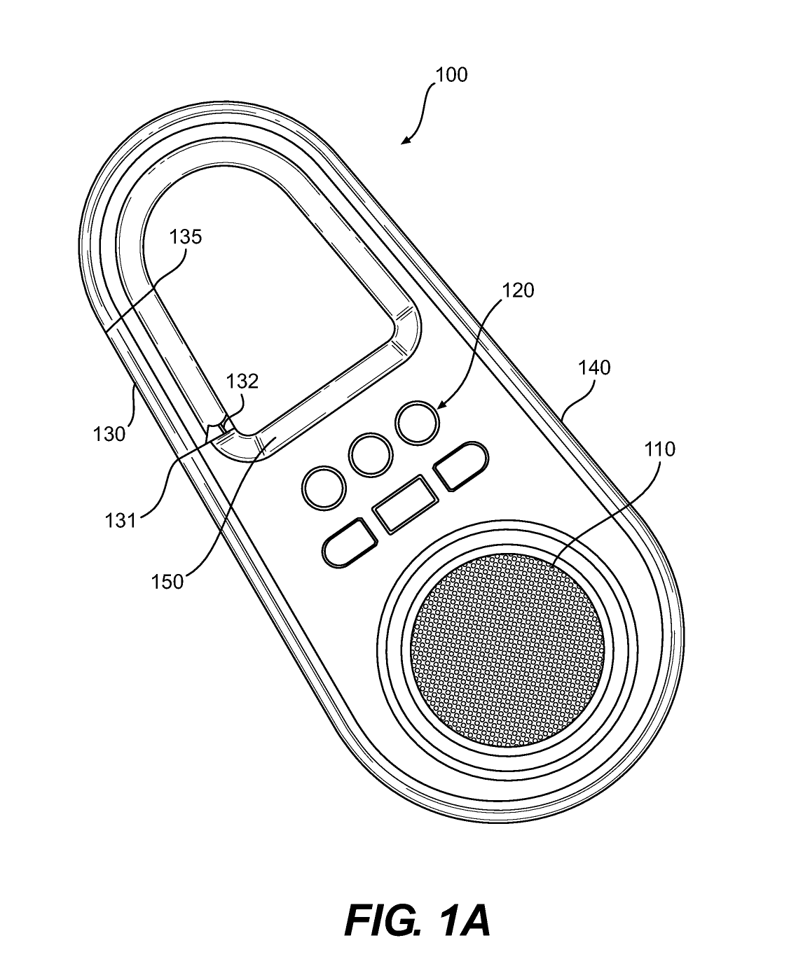

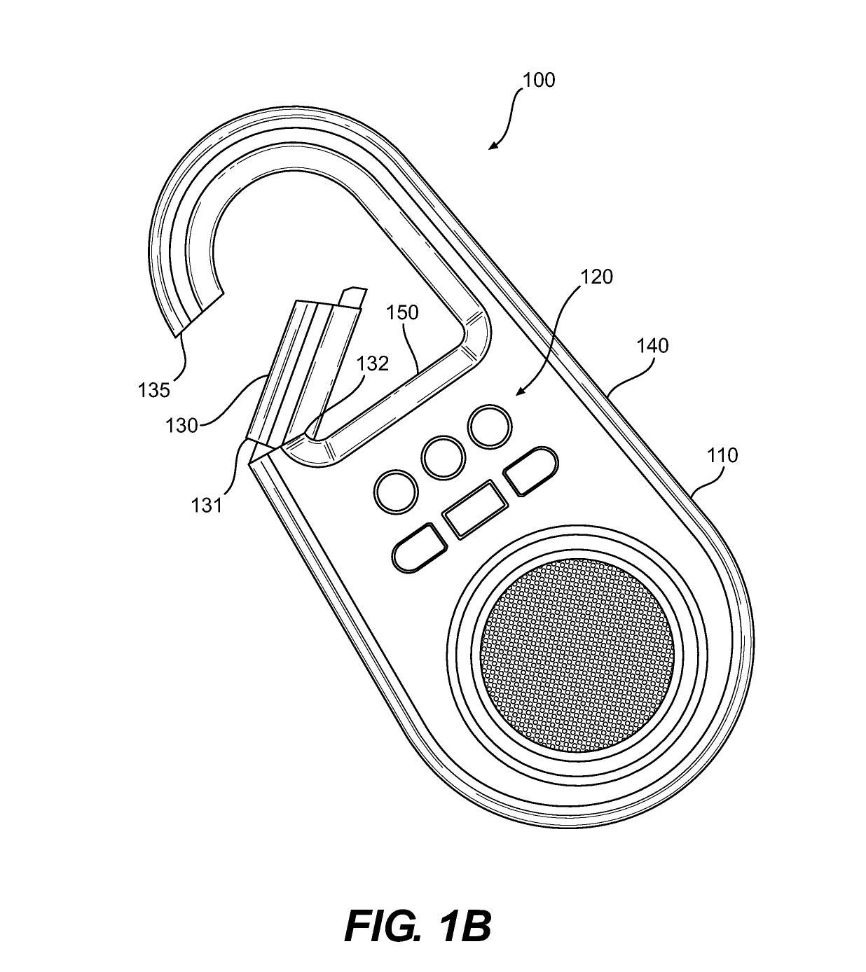

FIG. 1 illustrates a front view of one embodiment of a portable audio device 100 including a gate member 130 in a closed configuration. According to one embodiment, the portable audio device 100 is configured to output audio signals that have been generated by a source device through a speaker 110. One problem generally encountered when using a typical portable speaker is that the speaker may be connected to the source device using a wire. For example, a set of headphones are typically connected to a source device using a pair of wires joined to an input plug which is inserted into the source device. A wired connection may be undesirable because the wire used for connecting the portable speaker to the source device may become tangled, or may pull or snag on objects while a user is in motion. For example, when a user is running with a set of headphones on, the runner's arms may become tangled in the connection wire, or the wire may get caught on nearby objects, causing the headphones to fall off the user's head and/or causing damage to the headphone wire. In addition, a wired connection may prevent the source device and the output device from being located in different environments or areas. For example, a user using a set of headphones cannot store the source device in a backpack or purse without leaving a portion of the backpack or purse open to accommodate the wired connection. Using a wired connection, a user also cannot position the source device in one room and the output device in another room without being encumbered by a long connection wire. Accordingly, in one embodiment, the portable audio device 100 may be configured to wirelessly receive audio signals from a source device that transmits audio signals.

In addition, according to some embodiments, the portable audio device 100, or a portion thereof, may be waterproof to advantageously allow audio output in environments where water may be present. Accordingly, the combination of a wireless connection and a waterproof portion allows a user to place the portable audio device 100 in an environment where water may be present, while safely placing the source device in an environment in which the source device is not likely to come into contact with water. Such an arrangement may be desirable when the source device is not waterproof and may be damaged by water, but the user would like to hear audio outputted by the source device in an environment where water is present. For example, when a user wants to listen to music in a shower, the user may place the portable audio device 100 in the shower and place a source device, such as a computer or audio-enabled mobile phone, outside of the shower. As the portable audio device 100 is waterproof, it will not be damaged in the shower, and as the source device is located in a dry environment outside of the shower, it will not be exposed to water. Further, as the connection between the portable audio device 100 and the source device is wireless, the user need not leave a portion of the shower door open to accommodate a wired connection.

Generally, portable audio devices are light weight and/or small and easily moved from one location to another. A desirable portable audio device needs to not only be small, but also be able to generate sound that is pleasing. In addition portable audio devices that are intended for open-air listening must generate output that is powerful enough to be heard from several feet away. Open-air listening may be desirable in a group setting, for example. Thus, the design of an audio output device that is both portable and conducive to open-air listening must take into consideration size constraints, while also making sure that the device is powerful enough to generate loud-enough audio. Current devices attempting to satisfy these requirements, however, generally do not produce a pleasing sound because speakers disposed within a small housing tend to introduce standing waves into the housing cavity. Standing waves are introduced because sound waves generated by the speaker travel a short distance before being reflected off the interior surface of the housing. These standing waves may affect the generated sound because, when a standing wave is produced, it may resonate at a frequency that is out of phase with the waves being produced by the speaker 110. As a result, the quality of the sound reaching a listener's ear may be negatively affected.

One method of eliminating standing waves is by incorporating ports or holes in the speaker housing, thereby allowing some sound waves to escape the speaker housing, and preventing the formation of standing waves within the housing cavity. Another similar method involves making the housing out of a material that is porous, such as wood, so that portions of the sound waves can escape. Such methods, however, are generally not feasible when the housing is waterproofed; methods of allowing air to escape the housing may also allow water to enter the housing.

Accordingly, in some embodiments, the portable audio device 100 is designed to be small, compact, and waterproof, yet capable of producing a balanced and pleasing sound desirable for music or audio playback applications. The portable audio device 100 eliminates standing waves within its housing 140 by incorporating a design that eliminates right angles and parallel walls within the cavity. For example, as illustrated in FIG. 1, the portable audio device 100 has a roughly teardrop shape. Avoiding right angles and parallel walls reduces the likelihood that standing waves that are out of phase with sound waves emanating from the speaker will be formed. In structures with right angles and/or parallel walls, emanated sound waves hit corners or parallel walls in the housing, causing the waves to be reflected at angles that are different from their originating angles, and resulting in the out-of-phase standing waves that lead to lower sound quality.

It may be desirable in some applications to attach a portable audio device to another object to permit hands-free transport of the portable audio device. For example, a user may desire to attach a portable audio device to a backpack while hiking, to a showerhead while taking a shower, or to a loop inside a tent while camping.

One drawback associated with current attachments for portable speakers is that they typically provide inadequate support and may be difficult to attach in certain situations. For example, a flat spring clip may not provide for secure attachment to a rope, because the device may slip and become unclipped, or because the clip may have been incorrectly attached to the rope due to difficulties in the attachment process. Some attachment designs offer a fabric loop that is glued or bolted to one end of a device. These fabric loop designs may also not be advantageous because fabric tends to wear over time, leading to an increased likelihood that devices incorporating these designs will eventually fail to provide adequate support.

Accordingly, the portable audio device 100 may utilize an integrated carabiner-style attachment mechanism to attach it to another object. In some embodiments, the portable audio device 100 may be configured to permit attachment to another object through the use of a gate member 130. The portable audio device 100 may also include a frame member 150 that forms a closed loop with the gate member 130 to place the portable audio device in a closed configuration, and secure it to another object. The gate member 130 may be hinged and disposed along one side of the housing 140 of the portable audio device 100, such that the gate member 130 is part of, and integrated with, the housing 140. The gate member 130 may be pivotable along a hinge 131. The hinge 131 may also include a spring 132 that maintains the gate member 130 in a closed configuration. As the gate member 130 is hinged and spring-loaded, the portable audio device 100 may be quickly connected to, and disconnected from, other objects. For example, the portable audio device 100 may be quickly connected to a backpack, belt loop, rope, pole, or frame. The gate member 130 may be a straight gate (such as the gate member illustrated in FIG. 1), or it may be a bent gate, wire gate, or other carabiner-style gate.

The gate member 130 may connect with an engaging member 135 that is integrated with, and part of, the housing 140. The engaging member 135 may include a tongue portion and the gate member 130 may include a groove portion, such that when the engaging member 135 engages the gate member 130 additional support is provided to maintain the gate member 130 in the closed configuration. In some embodiments, the engaging member 135 may include a nose portion for securing the gate member 130 in place, such as when the gate member 130 is a wire gate. The gate member 130 and the engaging member 135 may connect via other known methods. For example, the gate member 130 and the engaging member 135 may connect in a fashion consistent with carabiner-style clips, or the gate member 130 and the engaging member 135 may connect via magnets.

In some embodiments, the frame member 150 may be integrated with the housing 140 such that loop-facing portion of the frame member 150 forms one side of the housing, and the opposing side of frame member 150 forms a second side of the housing 140. By integrating the housing 140 within the frame member 150, the portable audio device 100 may be attached to objects securely without introducing a weaker material, such as fabric or plastic, into the attachment. The integration of housing 140 within the frame portion 150 also permits a user to utilize the portable audio device 100 as a traditional carabiner-clip in some applications. For example, the frame portion 150 may be weight bearing and allow a user to quickly connect one or more chain links together using the portable audio device 100.

In one embodiment, the portable audio device 100 includes a speaker 110. The speaker 110 may be disposed within the housing 140. In some embodiments, the speaker 110 may be waterproof. For example, the cone of the speaker 110 may be made of material suitable for water exposure, but still capable of sufficient vibration to create sound, such as polypropylene. The speaker 110 may be covered by a rust proof metal mesh or cover, or alternatively, a plastic mesh cover, to protect the cone of the speaker from impact damage. The speaker 110 should be of sufficient wattage to produce sound at a volume suitable for open-air listening, while still being able to easily receive power from a battery source. For example, the speaker 110 may be a 2 watt speaker.

One or more control buttons 120 may be disposed on the front of the housing 140. The control buttons 120 may be used to adjust speaker volume, establish connections with the source devices, and/or send commands to a source device to control the playback of audio. For example, when pressed, one of the control buttons may generate a signal that corresponds to a command to pause the audio. The signal may then be transmitted to the source device and cause the audio to temporarily stop playing. The control buttons 120 may correspond to other commands affecting playback such as next track, previous track, stop, or play, for example.

FIG. 1B illustrates a front view of one embodiment of a portable audio device 100 with a gate member 130 in an opened configuration. When in the opened configuration, the gate member 130 may be disengaged from the engaging member 135 thereby allowing attachment of the portable audio device 100 to another object. In some embodiments, the gate member 130 is connected to a spring 132 that applies force to the gate member to maintain the closed configuration, and a counterforce may need to be applied to the gate member 130 to maintain the open configuration. For example, when a user attempts to attach the portable audio device 100 to her belt, the user might press the gate member 130 into the closed-loop area formed by the gate member 130 and the frame portion 150 to disengage the gate member 130 from the engaging member 135. Once the user has attached the portable audio device 100 to her belt, she may release the gate member 130. The spring 132 will provide force along the hinge 131 to snap the gate member 130 back into the closed configuration, reengaging the gate member 130 with the engaging member 135.

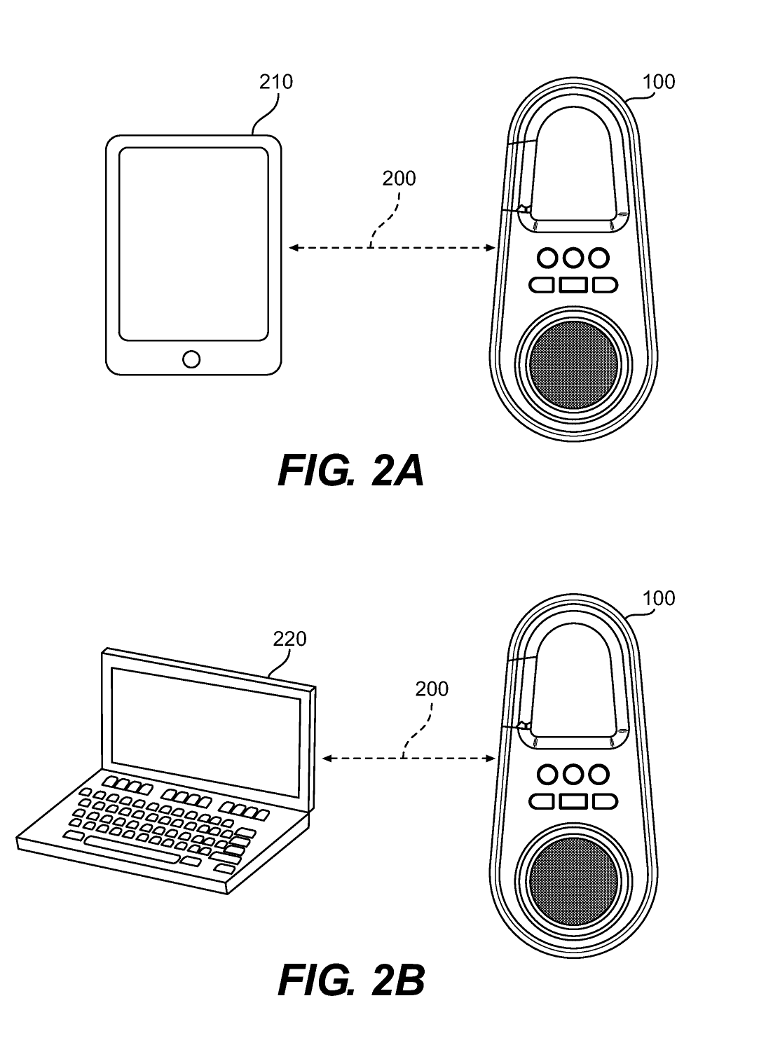

FIG. 2A illustrates one embodiment of a portable audio device 100 in communication with a source device 210. In the embodiment illustrated in FIG. 2A, the source device 210 is a mobile device 210, such as an MP3 player, cellular telephone, or tablet device. The portable audio device 100 may communicate with the source device 210 via a wireless connection 200. The wireless connection 200 may be established by any known wireless communication method. For example, the wireless connection 200 may include a Bluetooth® connection, a Wi-Fi Direct™ connection, an ad-hoc independent basic service set (IBSS) connection, or a traditional basic service set connection as defined in the IEEE 802.11 specification. The mobile device 210 may execute an application that outputs audio, such as a media player. The audio signal output of the audio application may be transmitted across a wireless connection 200 to the portable audio device 100. In some embodiments, the portable audio device 100 may transmit commands to the mobile device 210. For example, the portable audio device 100 may transmit a command over wireless connection 200 to the mobile device 210 to establish a connection relationship with the mobile device 210, such as when the wireless connection 200 is a Bluetooth® connection. In another example, the portable audio device 100 may transmit commands to control the application outputting audio that is executing on the mobile device 100. For example, the portable audio device 100 may transmit a command to pause playback, skip to another track, or adjust the volume of playback.

FIG. 2B illustrates one embodiment of a portable audio device 100 in communication with a source device 220. In the embodiment illustrated in FIG. 2B, the source device 220 is a general computing device 220 such as a laptop, desktop, or server computer. The general computing device 220 may execute an application that outputs audio signals such as music, audio tracks accompanying video, or system sounds. Similar to the embodiment illustrated in FIG. 2A, the wireless connection 200 may be a known method of wireless communication, and the source device 220 may send audio signals to the portable audio device 100 while the portable audio device 100 may send control signals to the source device 220.

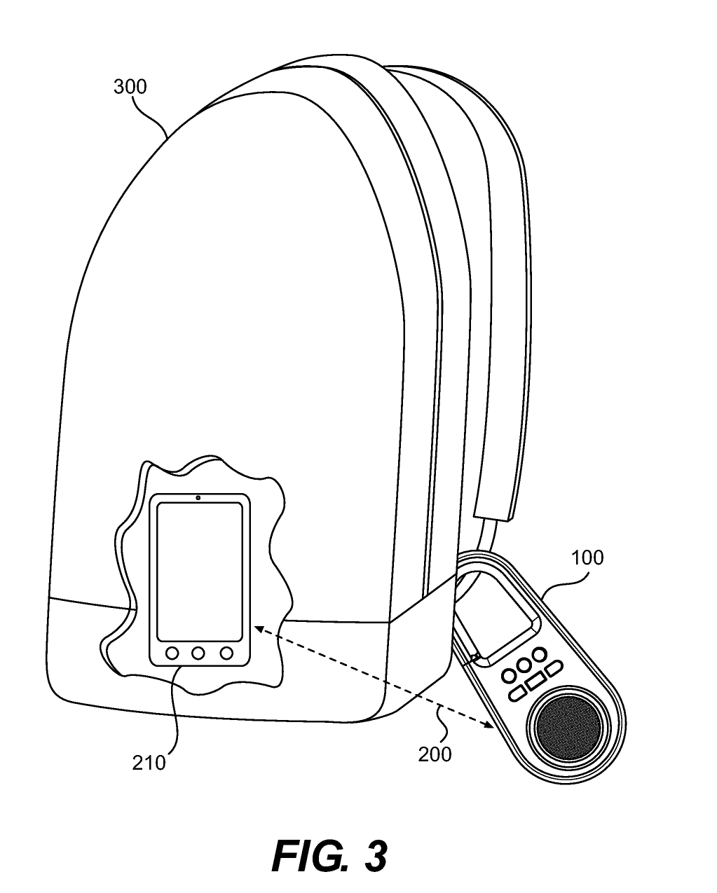

FIG. 3 illustrates one embodiment of the portable audio device 100 in a closed configuration and attached to a backpack 300. The portable audio device is in communication with a source device 210 via wireless connection 200. As illustrated in FIG. 3, the use of a wireless connection between the source device 210 and the portable audio device 100 advantageously allows a user to attach the portable audio device 100 to the exterior of the backpack 300, while also allowing the user to store the source device 210 within the backpack 300. By storing the source device 210 within the backpack 300, the user may protect the source device from environmental conditions that may be damaging to the source device 210, such as rain. Also, by attaching the portable audio device 100 to the backpack, the user may continue to listen to audio produced by the source device 210. As the portable audio device 100 may have a waterproof portion that protects the components of the device, the portable audio device 100 may be protected from damage in the event it begins to rain.

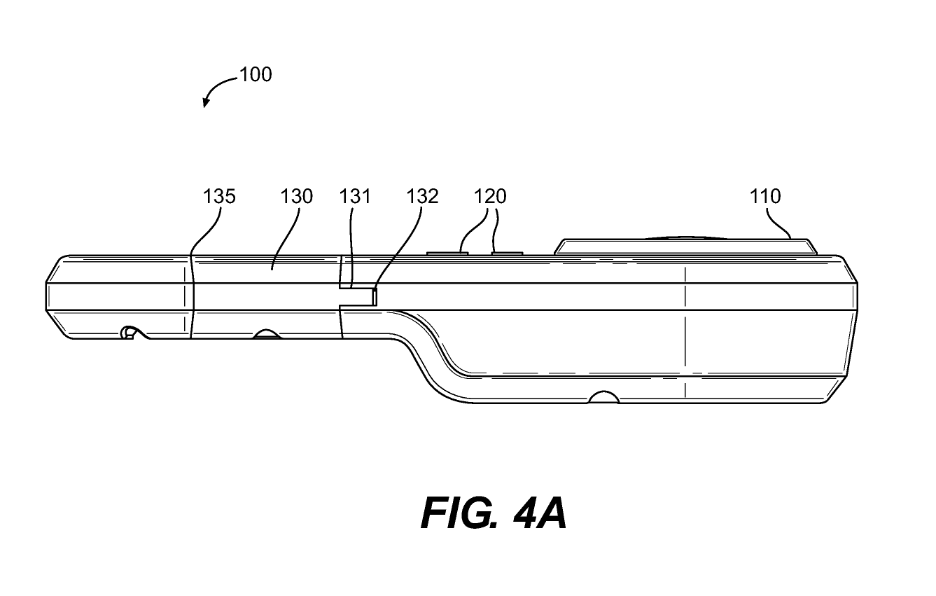

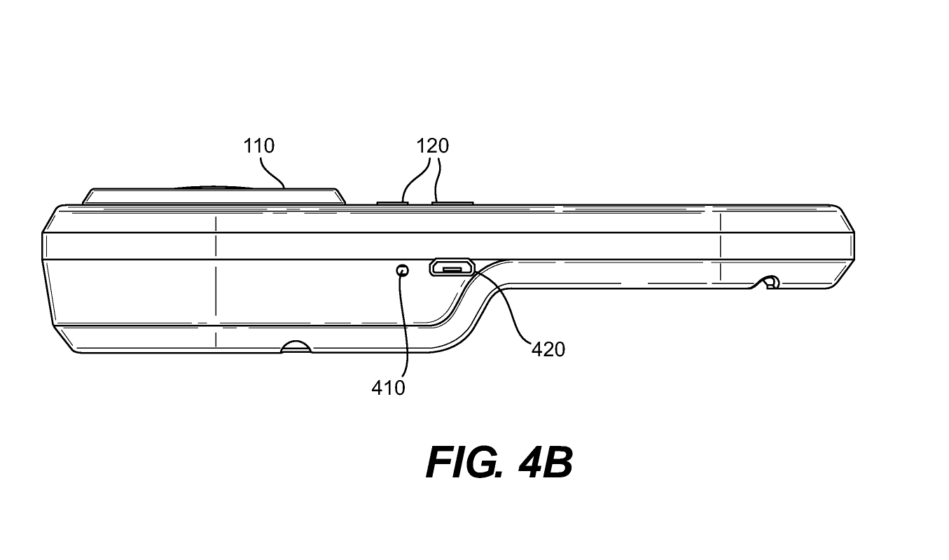

FIG. 4A illustrates a left-side view of one embodiment of a portable audio device 100 with a gate member 130 in a closed configuration. As shown in the left-side view of FIG. 4A, while in the closed configuration, the gate member 130 engages with the engaging member 135. The spring 132 may apply a force to secure the gate member 130 to the engaging member 135. While engaged, the left-side of the portable audio device 100 forms a closed loop with the frame member 150. Accordingly, once in the closed configuration, the portable audio device 100 will be securely attached to other objects with a low likelihood of disconnection. The gate member 130 may be disengaged from the engaging member 135 when a user exerts a force along the gate member 130 in the opposite direction from the force exerted on the gate member 130 by the spring 132.

FIG. 4B illustrates a right-side view of one embodiment of a portable audio device 100. As shown in FIG. 4B, the portable audio device 100 may include a microphone 410. The microphone 410 may be adapted to receive audio input signals, which are then sent over wireless connection 200 to a source device such as source device 210 or 220, as depicted in FIGS. 2A and 2B. In some embodiments, the source device may be a mobile or cellular phone. When the portable audio device is connected to a mobile or cellular phone, the portable audio device 100 may act as a remote speakerphone. In such and other embodiments, the microphone 410 may detect the user's speech, and the portable audio device 100 may transmit speech data to the source device 210 or 220. The source device may thereafter process the speech data and transmit audio data to the portable audio device 100 in response to the received speech data. When the portable audio device 100 is used as a speakerphone, which may require the near real-time transmission of audio data across wireless connection 200, it is preferable to that the wireless connection be sufficiently responsive to facilitate conversation. For example, a Bluetooth® connection may be appropriate in such an application.

In some embodiments, the portable audio device 100 may include a port 420. The port 420 may be used to connect the portable audio device 100 to a power source that is capable of charging a battery located within the device. The port 420 may also be used to provide software or firmware updates to the portable audio device 100. In some embodiments, the portable audio device 100 may facilitate a wired connection to the source device 210, and the port may provide a connection point for a wire. Such a connection may be desirable when the battery of the portable audio device 100 is not charged, when the wireless capability of the portable audio device 100 is damaged or otherwise compromised, or when a wireless connection is unnecessary. The port 420 may be any known industry standard port. For example, the port may be a USB, an IEEE 1394 (firewire), a R232 serial bus, or a Lightening™ port.

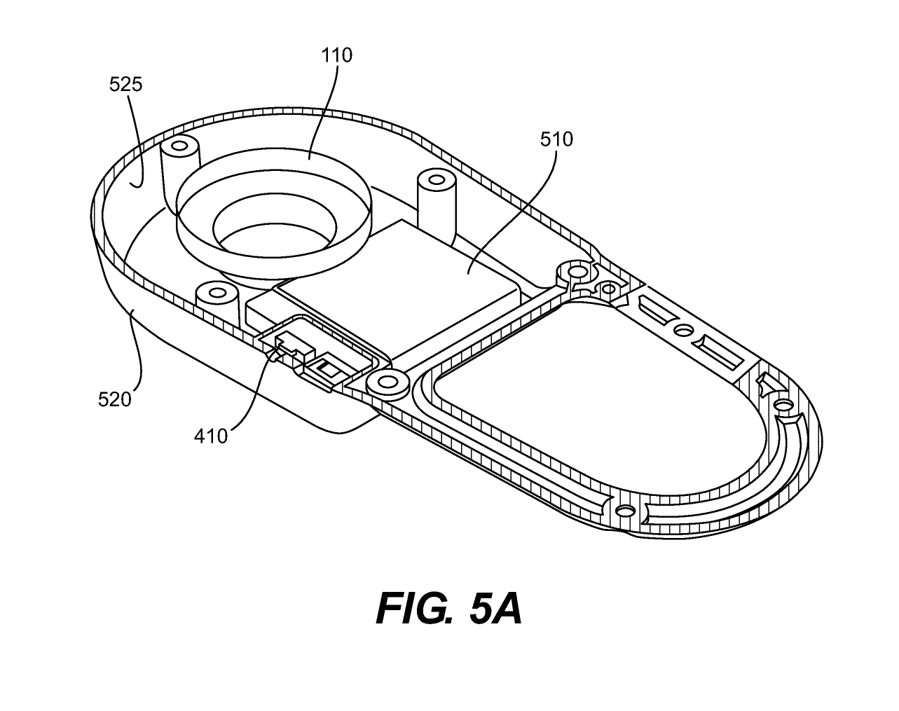

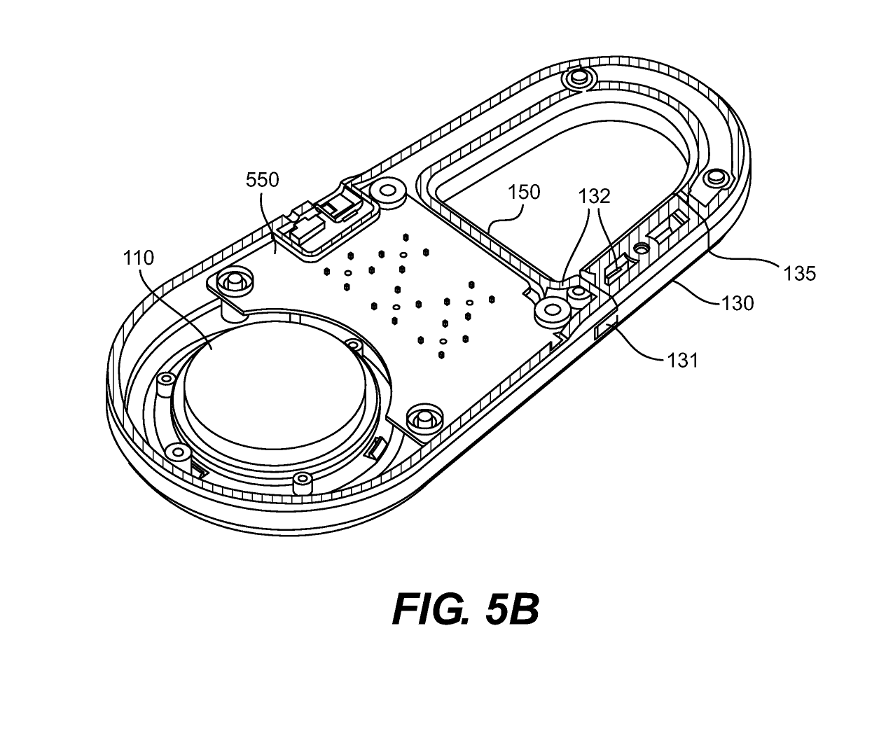

Turning now to FIG. 5A, a horizontal cross-section view of the bottom portion of the portable audio device 100 according to one embodiment is illustrated. In some embodiments, the portable audio device 100 may include a battery 510. The battery 510 may be a rechargeable battery that can be recharged when the portable audio device 100 connects to an external power source. In one embodiment, the battery is a lithium-ion battery to provide sufficient power to the amplifier and speaker of the portable audio device 100. Other batteries may be used in alternative embodiments.

In one embodiment, the housing 140 may include an exterior surface 520 and an interior surface 525. The interior surface 525 may be made of, or include, a waterproof material such as neoprene or rubber. When the interior surface 525 is waterproofed, and the exterior surface 520 of the housing 140 becomes exposed to water, the interior surface 525 protects the components residing within the housing 140 from water damage. For example, if the portable audio device 100 was submerged in water, the interior surface 525 would protect the components in the housing 140, such as speaker 110, battery 510, and microphone 410, although the exterior surface 520 would be exposed to water. In some embodiments, the interior surface 525 may be fitted with a waterproof seal or gasket to prevent water from entering the housing 140. The exterior surface 250 may also be fitted with a waterproof seal or gasket in addition to, or in lieu of, waterproof seals or gaskets fitted on the interior surface.

FIG. 5B illustrates a horizontal cross-section view of a top portion of a portable audio device 100 according to one embodiment. The portable audio device 100 may include a printed circuit board (PCB) 550 that contains modules capable of handling the computing needs of the portable audio device 100. For example, the PCB may include logic circuits capable of initiating communication with a source device 210 or 220. In one embodiment, the PCB 550 may include a Bluetooth® chip that establishes a Bluetooth® wireless connection with the source device, transmits data to the source device, and receives data from the source device. The PCB 550 may also include, for example, logic that processes audio data received from the source device and control data that is to be sent to the source device. The PCB 550 may also provide a connection point for the control buttons 120 to initiate the transmission of control signals.

As shown in FIG. 5B, the housing 140 of the portable audio device 100 may be integrated with the frame member 150 such that the housing 140 and the frame member 150 share an exterior surface. The integration of the housing 140 with the frame member 150 allows for the portable audio device to be attached to objects securely. In addition, the integration of the frame member 150 with the housing 140 allows the portable audio device 100 to be used as a standard carabiner clip.

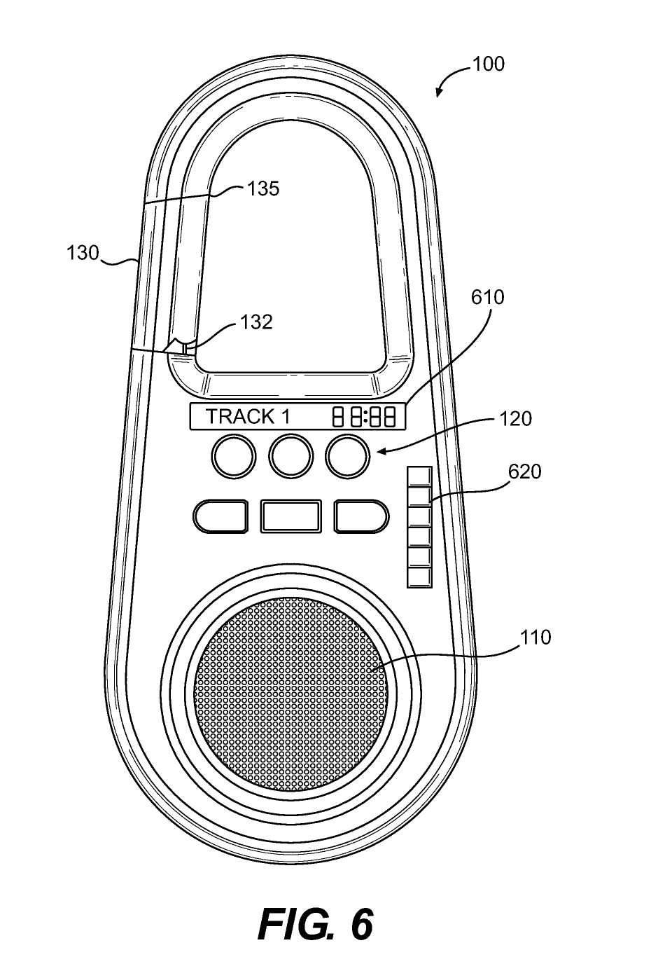

Turning now to FIG. 6, one embodiment of a portable audio device 100 with a gate member 130 in a closed configuration will be disclosed. In the embodiment of FIG. 6, the portable audio device 100 includes a photovoltaic cell 620 that is connected to the battery 510. The photovoltaic cell may provide a supplement power source to the battery 510, or may provide a power source to the battery 510 for charging purposes. The portable audio device 100 may also include a display 610. The display 610 may be a LED or LCD display, for example. The display 610 may show additional data or information related to the audio being received by the portable audio device 100 from the source device 210 or 220. For example, the display 610 may show audio track information for a song being played such as the title of the current track, an artist associated with the current track, the time lapsed, or the time remaining for the track. The display 610 may also show connection status information. For example, it may show “Connected” upon the establishment of a wireless connection with a source device 210 or 220. The display 610 may show “Disconnected” when the wireless connection is terminated, or when the portable audio device 100 moves out of range of the source device.

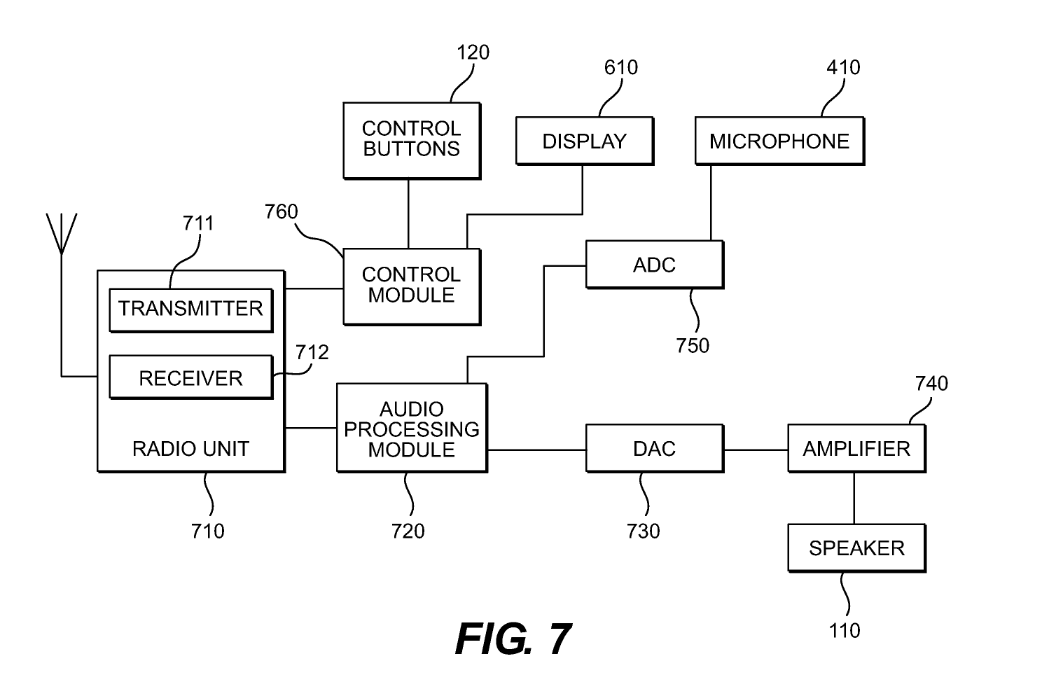

FIG. 7 illustrates a block diagram of components of a portable audio device according to one embodiment. The block diagram includes one or more modules, such as audio processing module 720 and control module 760. In general, the word module, as used herein, refers to logic embodied in hardware or firmware, or to a collection of instructions, possibly having entry and exit points. Modules may be callable from other modules or from themselves, and/or may be invoked in response to detected events or interrupts. Software modules may be stored in any type of computer-readable medium, such as a memory device (e.g., random access, flash memory, and the like), an optical medium (e.g., a CD, DVD, BluRay, and the like), firmware (e.g., an EPROM), or any other storage medium. Hardware modules may be comprised of connected logic units, such as gates and flip-flops, and/or may be comprised of programmable units, such as programmable gate arrays or processors. The modules described herein may be implemented as hardware, firmware, or software modules. Generally, the modules described herein refer to logical modules that may be combined with other modules or divided into sub-modules despite their physical organization or storage.

The block diagram of FIG. 7 also illustrates one or more components such as speaker 110, control buttons 120, microphone 410, radio unit 710, digital-analog converter (DAC) 730, amplifier 740, and analog-digital converter (ADC) 750. Some of the one or more components may be embodied on integrated circuit chips or may be embodied on the PCB. The functionality provided by the components may be combined into fewer components or further separated into additional components without detracting from the sprit and scope of the present disclosure. For example, although FIG. 7 shows a block diagram where the audio processing module 720, the DAC 730, and the ADC 750 are separate modules and components, in some embodiments the audio processing module 720 may include the DAC and the ADC.

In some embodiments, the portable audio device 100 may include a radio unit 710. The radio unit 710 may include a transmitter 711 and a receiver 712 for sending and receiving data from the source device 210 or 220. In one embodiment, the radio unit includes a Bluetooth® capable radio unit. The radio unit may be included on PCB 550 or may be a separate integrated circuit chip.

In some embodiments, the portable audio device 100 may include an audio processing module 720. The audio processing module 720 may include logic for processing audio data received by the radio unit 710. For example the radio unit 710 may receive packets of data representing audio for playback, and the audio processing module 720 may extract audio information from the audio data packets to create an audio data stream. In some embodiments, the audio processing module 720 may additionally processes the audio data stream to make the audio more suitable for output to the speaker. For example, the audio processing module 720 may apply compression to the audio data stream, or it may convert a stereo audio data stream to a mono data stream. The audio data stream may then be sent to the DAC 730 to be converted to an analog audio signal. The portable audio device 100 may also include an amplifier 740. The amplifier 740 may receive analog audio signals from the DAC 730 and amplify them for output to the speaker 110.

The audio processing module 720 may also be configured to create audio data packets that are sent back to the source device 210 or 220 via the radio unit 710. For example, when a user speaks into the microphone 410, the microphone converts the sound waves from the user's voice to an analog electrical signal. The ADC 750 may receive analog data from the microphone 410 and convert it to digital data, which is then sent to the audio processing module 720. The audio processing module 720 may convert the digital data to data packets that can then be sent to the source device 210 or 220 by radio unit 710.

In some embodiments, the portable audio device 100 may also include a control module 760. The control module 760 may receive input data from the control buttons 120, and generate data packets containing command data corresponding to the control buttons. The generated data packets containing command data may then be transmitted to the source device via the radio unit 710. The control module 760 may also receive data from the radio unit 710 that is intended to be shown on display 610, such as audio track information. The control module may then command the display 610 to render the data on the display.

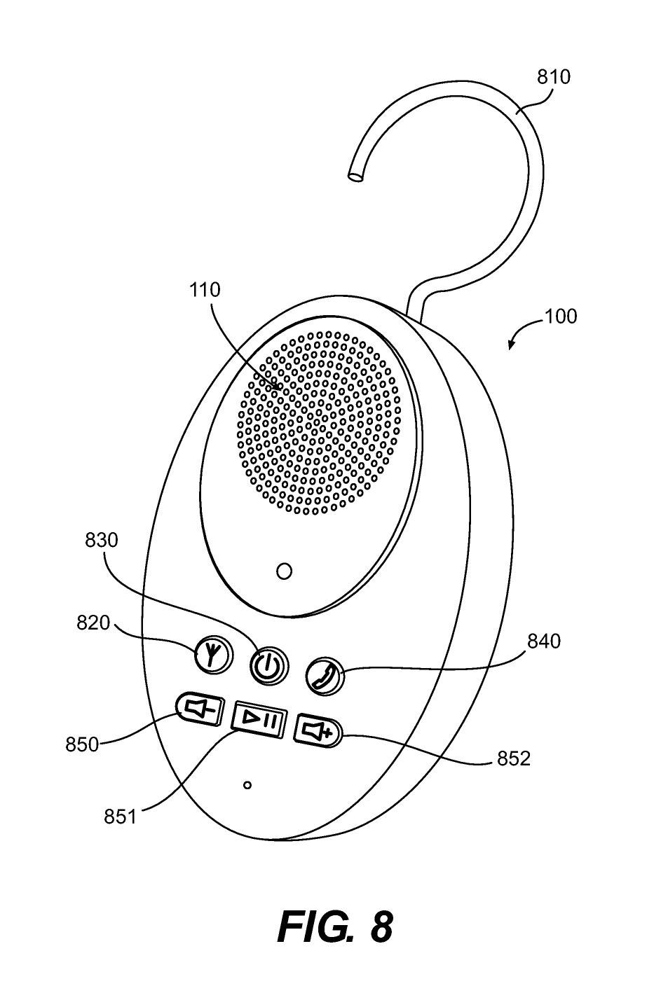

FIG. 8 illustrates a front view of an example embodiment of a portable audio device 100 with a hook member 810. The embodiment of FIG. 8 is intended to be attached to another object via the hook member 810 in an environment where water may be present, such as in a shower or on an outdoor patio. Accordingly, the housing of the portable audio speaker is waterproof. FIG. 8 shows an embodiment of the portable audio device where the shape of the housing is oval, thereby minimizing the occurrence of standing waves. Standing waves may create unwanted peaks and dips in the frequency response of the portable audio device. As standing waves may be created by right angles, the housing of the portable audio device 100 as illustrated in FIG. 8 is advantageously oval in shape. The portable audio device may include several dedicated control buttons. For example, it may include: a wireless connection button 820 that, when pressed by a user, establishes a wireless connection with a source device; a power button 830 that turns the portable audio device on and off; a phone button 840 that may be used by the user to answer an incoming call; a volume-down button 850 that can be used to reduce the output volume of the speaker 110, a play or pause button 851 that can be used to pause and unpause audio; and a volume-up button 852 that can be used to increase the output volume of the speaker 110.

Other embodiments will be apparent to those skilled in the art from consideration of the specification and practice of the embodiments disclosed herein. It is intended that the specification and examples be considered as exemplary only.

What is claimed is:

1. A portable audio device comprising:
a loop portion, the loop portion comprising a spring-activated gate member;
a waterproof housing;
a wireless receiver disposed within the waterproof housing, and adapted for receiving an audio signal; and
a speaker connected to the wireless receiver, and adapted to output the audio signal received by the wireless receiver,
wherein the waterproof housing and the loop portion are connected such that they share an exterior surface.

2. The portable audio device of claim 1, wherein the wireless receiver is adapted for wireless communication with a source device.

3. The portable audio device of claim 1, further comprising a transmitter.

4. The portable audio device of claim 3, further comprising a microphone.

5. The portable audio device of claim 4, wherein the transmitter is connected to the microphone and the transmitter is adapted to transmit audio input signals detected by the microphone.

6. The portable audio device of claim 3, further comprising one or more control buttons.

7. The portable audio device of claim 6, wherein the transmitter is adapted to transmit control signals generated in response to the activation of the one or more control buttons.

8. The portable audio device of claim 7 wherein the control signals are configured to control an application executing on a source device.

9. The portable audio device of claim 1, further comprising a photovoltaic cell.

10. The portable audio device of claim 1, further comprising an amplifier disposed within the waterproof housing.

11. The portable audio device of claim 10, wherein the amplifier is connected to the wireless receiver and the speaker, and wherein the amplifier is adapted to produce sufficient power to drive the speaker.

12. The portable audio device of claim 1, further comprising an integrated circuit capable of establishing a communications connection to a master device.

13. A portable audio device comprising:
a carabiner clip comprising a gate and a frame;
an oval shaped waterproof housing disposed within the frame of the carabiner clip;
a wireless receiver disposed within the waterproof housing;
a wireless transmitter disposed within the waterproof housing; and,
a speaker disposed within the waterproof housing, the speaker connected to the wireless receiver and adapted to output audio signals received by the wireless receiver.

14. The portable audio device of claim 13 further comprising one or more control buttons.

15. The portable audio device of claim 14, wherein the wireless transmitter is adapted to transmit control signals generated in response to the activation of the one or more control buttons.

16. The portable audio device of claim 13 further comprising an integrated circuit capable of establishing a communications connection to a source device.

17. The portable audio device of claim 13 further comprising a microphone.

18. The portable audio device of claim 17 wherein the wireless transmitter is connected to the microphone, and the wireless transmitter is adapted to transmit audio input signals detected by the microphone.

19. A device housing comprising:
a first edge capable of being configured in an open configuration or a closed configuration;
a spring-loaded hinged member pivotable along a first edge of the device housing;
an engaging member disposed along the first edge, the engaging member adapted to couple to the spring-loaded hinged member such that when the spring-loaded hinged member couples to the engaging member, the spring-loaded hinged member and the engaging member place the first edge in the closed configuration, and such that when the spring-loaded hinged member decouples from the engaging member, the spring-loaded hinged member and the engaging member place the first edge in an open configuration;
a second edge comprising an exterior surface and an interior surface, the interior surface forming a component cavity;
one or more waterproof seals disposed within the component cavity, or disposed along the exterior surface to prevent water from entering the component cavity when the exterior surface is exposed to water.

20. The device housing of claim 19, further comprising at least one of a wireless receiver, a speaker, and one or more control buttons.
